(19) United States
(12) Patent Application Publication
(10) Pub. No.: US 2025/0239758 A1
(43) Pub. Date: Jul. 24, 2025

(54) DIRECTIONAL VEHICLE RADAR SYSTEM ANTENNA

(71) Applicant: OPmobility SE, LYON (FR)

(72) Inventors: Mathieu BANCELIN, Sainte-Julie (FR); Romain CRETIER, Sainte-Julie (FR); Laurent ROCHEBLAVE, Sainte-Julie (FR); Frédéric STABLO, Sainte-Julie (FR)

(73) Assignee: OPmobility SE, LYON (FR)

(21) Appl. No.: 18/687,137

(22) PCT Filed: Sep. 2, 2022
(86) PCT No.: PCT/EP2022/074495

§ 371 Date: Jan. 28, 2025

(30) Foreign Application Priority Data
Sep. 3, 2021 (FR) FR2109252

(51) Int. Cl. H01Q 1/32; G01S 7/03; G01S 13/931; H01Q 3/46; H01Q 15/00

(52) U.S. Cl. CPC H01Q 1/3283; G01S 7/032; H01Q 3/46; H01Q 15/0066; H01Q 15/0086; G01S 2013/93271; G01S 2013/93274

(57) ABSTRACT

Directional antenna for a motor vehicle radar system includes a housing comprising a reflecting envelope comprising an inner volume forming a reflecting cavity for electromagnetic waves, characterized in that the reflecting envelope is bounded by a set of walls including a first transmission wall comprising an electromagnetic wave transmission zone between the inside and the outside of the housing; a second guide wall, opposite the first wall, able to guide electromagnetic waves in a privileged direction; and a set of reflective lateral walls connecting the first and second walls, wherein each lateral wall is able to reflect the electromagnetic waves within the reflective cavity.

The present disclosure relates to the field of motor vehicles, for example motor vehicles equipped with a radar system for emitting and/or receiving an electromagnetic wave in a desired direction, in particular for detecting an obstacle.

Motor vehicles equipped with radar-type devices, generally positioned on the front and rear bumpers of the vehicle, are known. These radar devices are used for parking assistance but also for driving assistance, for example for applications for regulating vehicle speed as a function of traffic better known by the acronym ACC (“Adaptive Cruise Control”) wherein the radar device detects the speed and the distance of a vehicle preceding the vehicle carrying the radar device. Such a radar is used in particular to regulate the speed of vehicles as a function of the traffic and/or obstacles on the road. The radar detects the speed and the distance of the object preceding the carrier vehicle, so as to maintain in particular a safety distance between the vehicles.

In general, an important area of motor vehicle industry radar applications is that of vehicle bodywork, wherein more and more radar modules are integrated in order to allow total peripheral detection around the vehicle, for example for equipment such as systems for assisting in parking maneuvers, reversing assistance systems or pedestrian protection facilities or other systems of this type. However, these various radars are of different types depending on their detection field (long or short distance, front detection or lateral detection, etc.) and their function (parking, autonomous driving, etc.) but also according to their manufacturer, which does not allow them to be able to optimally consolidate the data provided by each independently to the various equipment of the vehicle which can use them (braking, direction, headlights, sound or visual alarms, etc.).

Thus, in order to better characterize the peripheral environment of the vehicle, motor vehicle manufacturers need devices making it possible to improve, on the one hand, the size of the volume to be monitored around the vehicle, and on the other hand, the resolution of the processing of the information coming from these devices. This is in order for the vehicle to interact best, that is with more precision and more quickly, with its environment, in particular to avoid accidents, facilitate maneuvers and operate autonomously.

In order to increase the peripheral detection by volume (3D) around the vehicle, automobile manufacturers are led to multiply the number of radars distributed over a given surface.

However, the increase in the number of radars used leads to an increase of the cost.

In addition, the increase in the number of radars requires a continuous supply of numerous radiofrequency tracks, which consumes a lot of energy, which is very detrimental in particular for autonomous and/or electric vehicles.

Moreover, even if the radars can be slightly miniaturized, the increase in the number of radars distributed over a given surface may be difficult to produce due to the limited available area (the size of the bodywork parts cannot be increased) as well as the presence of other equipment, all the more so since it may be necessary to maintain a minimum distance between each radar in order to prevent them from interfering with each other.

In order to obtain additional information relating to the position and speed of an obstacle given by the radars, devices having in particular an increased spatial resolution are sought, making it possible for example to recognize the objects (environment or obstacles) surrounding the vehicle, to follow their trajectory, to constitute an image of the vehicle as complete as possible.

Thus, vehicles are increasingly equipped with devices complementary to radars, such as LIDAR and cameras.

The spatial resolution expresses the capacity of an observation device to distinguish the details. It can be characterized in particular by the minimum distance which must separate two contiguous points so that they are correctly discerned.

In the case of a radar, this resolution distance is a function of the ratio between the wavelength of the wave used for the observation, and the size of the opening of the observation device. Thus, to improve the spatial resolution, that is to say decrease the resolution distance, it is necessary to reduce the wavelength (increase the frequency of the wave) and/or necessary to increase the opening of the observation device. Indeed, the spatial resolution R is characterized by the following equation:

$$R = \frac{c * L}{f * O}$$

with c the speed of the light, L the distance between the observation device and the target, f the frequency of the radar and O the opening the observation device.

It is the reason why today we tend to use radars operating at a higher frequency, for example at 77 GHz instead of 24 GHz.

On the contrary, the miniaturization of current radars leads to reducing their opening and therefore their resolution.

Furthermore, a problem encountered for a radar carried by a bodywork part relates to the positioning of the radar. Indeed, it is important to be able to ensure the integrity of a radar, so that it fulfills its function correctly, even in the event of deformation of the bodywork part bearing it (impact, thermal expansion, etc.). It is therefore necessary to ensure good positioning of the radar (the direction of emission/reception maintained) throughout the duration of use of the radar function.

It is therefore appropriate to provide a solution making it possible to provide the position and the speed of the objects located around the vehicle and to obtain a more suitable range and spatial resolution, while limiting the cost and energy consumption of the detection device. This makes it possible to improve the detection of objects or persons around the vehicle and to facilitate the installation of such systems in autonomous vehicles, in particular electric vehicles whose consumption must be limited as much as possible.

Furthermore, regardless of the type of radar carried by a bodywork part, a problem encountered relates to the vulnerability to impacts of electronic components. Indeed, during a shock deforming the wall bearing the radar, there is a risk of damage to the components, such as the electronic unit bearing in particular the radar wave transceiver and their control electronics, disabling the radar function. However, the replacement of these components is expensive.

The object of the present disclosure is in particular to remedy the aforementioned drawbacks, by providing a directional antenna for a motor vehicle bodywork part, able to transmit (transmit and/or receive) an electromagnetic wave in a given direction from a large area (in relation to the size of the bodywork part itself).

To this end, the present disclosure relates to a directive antenna for a motor vehicle radar system comprising a housing comprising a reflecting envelope comprising an inner volume forming a reflecting cavity for electromagnetic waves, wherein the reflecting envelope is delimited by a set of walls comprising:
a first transmission wall comprising an electromagnetic wave transmission zone between the inside and the outside of the housing;
a second guide wall, opposite the first wall, able to guide electromagnetic waves in a preferred direction; and
a set of reflective lateral walls connecting the first and second walls, each lateral wall being able to reflect the electromagnetic waves within the reflecting cavity.

By virtue of such an antenna, it is possible to increase the opening of the radar system provided with such an antenna, without having to multiply the number of radars, and without having to multiply the electronic components.

In addition, thanks to the dissociation between the electronic unit and the directional antenna it is thus possible to position the directional antenna in an area of the vehicle making it possible to correctly image the environment of the vehicle, while positioning the electronic unit in a zone less subject to shocks.

A zone less subject to shocks is clear for specialists, and depends on the bodywork part on which the radar system is installed. For example, for a bumper, a zone less subject to shocks can be a recessed area of the outer skin, and/or a laterally offset area (toward the wings) relative to the vehicle and/or a vertically offset area (for example lower than the directional antenna).

According to other optional features of the radar system, taken either alone or in combination:
at least one of the walls comprises, on its external face to the cavity, a waveguide connector.
the external face to the cavity or the internal face of the second wall constitutes a surface reflecting electromagnetic waves present in the reflecting cavity.
the second wall constitutes a printed circuit.
the printed circuit comprises an internal face turned towards the interior of the reflecting cavity, and on which the metasurface is printed.
the metasurface comprises a controlled surface and diodes, and the printed circuit comprises on its external face, or is connected to, a secondary control electronics of the controlled surface.
the electromagnetic wave transmission zone is covered with a partially reflective layer to electromagnetic waves.
the assembly of reflecting walls are made of aluminum or plastic covered with a reflective layer able to reflect the electromagnetic waves in the reflecting cavity.
the assembly of reflecting walls is made in one piece.
the assembly of reflecting walls comprises a first pair of reflecting walls facing each other, and a second pair of reflecting walls facing and substantially perpendicular to the walls of the first pair.
the housing has a substantially parallelepiped shape.
the first pair of reflecting walls is able to fit tightly into the second pair of reflecting walls.
the housing comprises a cover and a receptacle made of plastic material.

The present disclosure also relates to a radar system comprising at least one directional antenna according to one of the preceding claims.

According to one embodiment, the radar system comprises:
an electronic unit located outside and at a distance from the housing, comprising a primary transmitter and a primary receiver of electromagnetic waves;
at least one waveguide for propagating electromagnetic waves between the primary transmitter and the cavity and between the cavity and the primary receiver.

According to a variant, the electronic unit can be configured to operate at frequencies greater than 60 GHz, in particular between 75 and 80 GHz, preferably at 77 GHz.

The present disclosure also relates to a bodywork part comprising a directional antenna according to the disclosure.

The present disclosure also relates to a motor vehicle comprising a bodywork part according to the disclosure.

### BRIEF DESCRIPTION OF DRAWINGS

The various disclosed embodiments will be better understood upon reading the following description, which is provided merely as example and with reference to the appended drawings, wherein:

FIG. 1 shows an example of a motor vehicle equipped with a radar system equipped with a directional antenna according to an embodiment.

FIG. 2 shows a perspective view of a first embodiment of a directional antenna according to an embodiment.

FIG. 3 shows a perspective and cross-sectional view of the directional antenna of FIG. 2.

FIG. 4 shows a perspective view, seen from above, of a second embodiment of a directional antenna according to an embodiment.

FIG. 5 shows a perspective view, seen from below, of the directional antenna of FIG. 4.

FIG. 6 shows an exploded view of the directional antenna of FIGS. 4 and 5.

FIG. 7 shows an exploded view of a third embodiment of a directional antenna according to an embodiment.

FIG. 8 shows a perspective and cross-sectional view of the directional antenna of FIG. 7.

FIG. 9 shows an example of an electromagnetic system for geophysical prospecting according to an embodiment.

### DETAILED DESCRIPTION

In the figures, identical elements bear the same references. The following embodiments are examples. Although the description refers to one or more embodiments, this does not necessarily mean that each reference relates to the same embodiment, or that the features apply only to a single embodiment. Simple features of different embodiments can also be combined or interchanged to provide other embodiments.

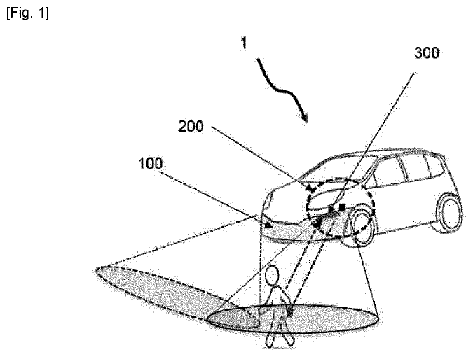

We refer to FIG. 1, which shows an example of a motor vehicle 1 equipped with a radar system 200 provided with a directional antenna 300 according to an embodiment.

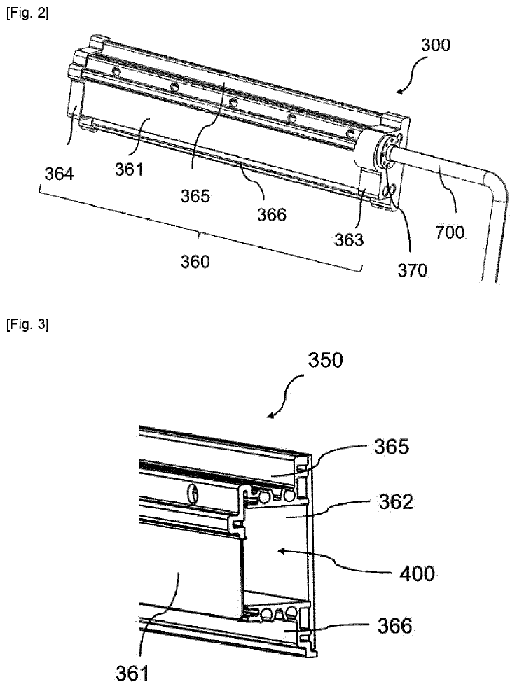

As shown in FIGS. 2 to 8, such a directional antenna 300 comprises a housing 350. The housing 350 comprises a reflecting envelope comprising an internal volume forming a reflecting cavity 400 for electromagnetic waves. The reflective envelope is delimited by a set 360 of walls comprising:
a first wall 361, called transmission wall 361, since comprising at least one electromagnetic wave transmission zone 426 between the inside and the outside of the housing 350. Furthermore, outside this zone, the transmission wall 361 is able to reflect the electromagnetic waves within the reflecting cavity 400.
a second wall, called guide wall 362, since provided with a metasurface 500 configured to guide electromagnetic waves in a preferred direction (toward the transmission wall 361, or to a waveguide 700). This guide wall is opposite the transmission wall 361. The guide wall 362 forms the bottom of the reflective envelope.
a set of reflective lateral walls 363-366 connecting continuously (without electromagnetic waves) the first 361 and second 362 walls, each lateral wall being able to reflect the electromagnetic waves within the reflecting cavity 400.

The housing 350 comprises fastening means and means for connection to various elements.

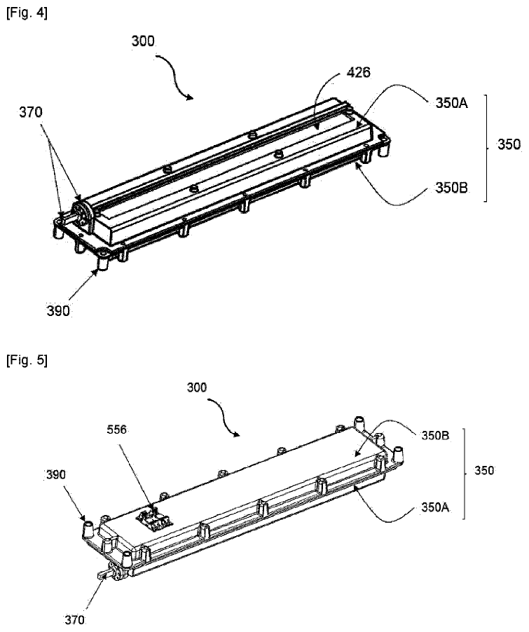

In particular, the housing comprises fastening means 390 (FIGS. 4 and 5 for example) to a bodywork part 100. These fastening means are configured so as to allow the antenna 300 to be positioned as close as possible to the internal surface (with reference to the vehicle) of the bodywork part 100, so as to limit the losses or the risk of reflection on the bodywork part.

In addition, at least one of the walls of the assembly 360 comprises, on its external face to the cavity 400, a waveguide 370 for a waveguide 700 (FIGS. 2 and 4 to 7). The housing 350 comprises an opening so that the waveguide 700 can pass through the housing 350 and the reflecting wall, so that the waveguide 700 opens into the reflecting cavity 400.

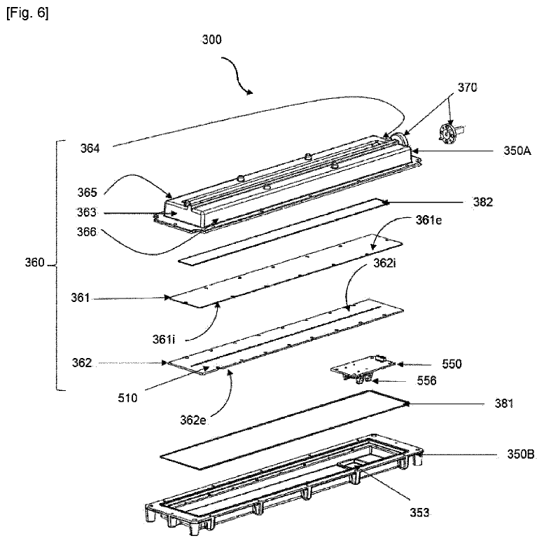

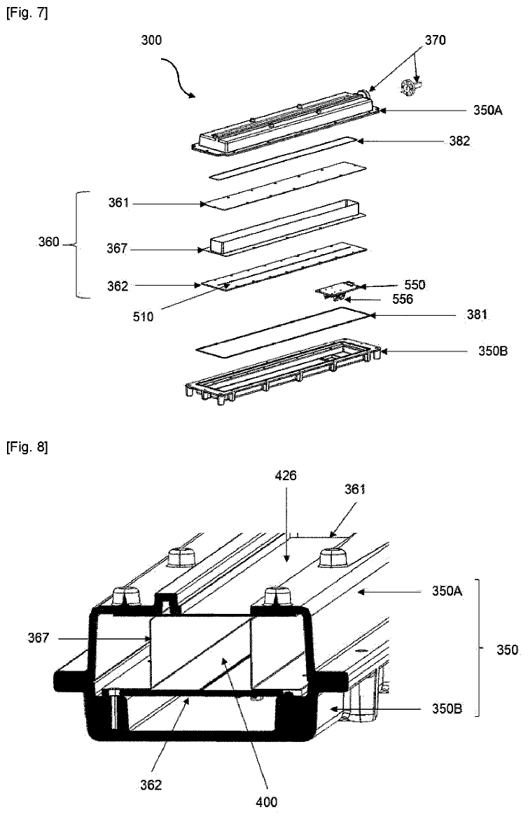

Preferentially, the housing 350 comprises sealing elements 381 and 382 (FIGS. 6 and 7), configured to make the housing 350 sealed to the environment.

The housing 350 may also comprise secondary control electronics 550 of the metasurface 500. This secondary control electronics 550 makes it possible for example to integrate the shift register necessary for controlling the controlled surface, or according to another example, to specialize the directional antenna 300 if the latter is part of a set of antennas. According to a preferred embodiment, this secondary control electronics is integrated directly into the guide wall 362, preferably on the external face to the cavity (362e).

### The Guide Wall 362

The guide wall 362 comprises an external face 362e to the reflecting cavity 400, and an internal face 362i to this cavity 400. The guide wall 362 makes it possible to guide the waves emitted in the cavity 400 by the waveguide 700 toward the transmission wall 361. Reciprocally, the guide wall 362 makes it possible to guide the waves received in the cavity 400 from the outside of the housing 350, after rebound on an obstacle, toward the waveguide 700.

The metasurface 500 comprises controlled surfaces and diodes. The guide wall 362 constitutes a printed circuit 510. The printed circuit 510 comprises an internal face 510i turned toward the interior of the reflecting cavity 400, and on which the controlled surfaces and preferences are in particular printed, on which the diodes are soldered.

The printed circuit 510 also comprises or is connected to control connection elements 556 (FIGS. 5-7) able to connect the metasurface to main control electronics (within the electronic unit 900 for example) of the controlled surface.

On the other face of the printed circuit 510, its external face 510e can be implanted from the electronic tracks and components having another function than the metasurface. For example, to integrate the shift register necessary for controlling the controlled surface.

According to one embodiment, the external face 510e of the printed circuit 510 constitutes a surface reflecting the electromagnetic waves present in the reflecting cavity 400. It may for example comprise a reflective layer such as a layer of copper. The guide wall 362 then forms the bottom wall of the reflective envelope. The bottom wall of the reflective envelope may also be another wall. For example, the bottom wall of a receptacle 350B (described below): such a wall is made of a material reflecting the electromagnetic waves or is covered with a reflective layer.

According to one embodiment, the guide wall 362 incorporates secondary control electronics (for example the shift register), preferably on the external face to the cavity (362e).

### The Transmission Wall 361

The first wall, transmission wall 361, comprises at least one electromagnetic wave transmission zone 426 between the inside and the outside of the housing 350. Furthermore, if the zone 426 does not cover the entire transmission wall 361, outside this zone 426, the transmission wall 361 is able to reflect the electromagnetic waves within the reflecting cavity 400.

To obtain the transmission property of the transmission zone 426, this zone may be:
made of a material different than the reflective material of the rest of the wall 361, this different material being at least partially permeable to electromagnetic waves;
made of a non-reflective material but covered with a layer partially reflective to electromagnetic waves;
forming a controlled area so as to modify its transmittance.

To obtain the reflection property in the reflective cavity 400, the wall 361 can be made, except opposite the zone 426:
made of a reflective material, such as metal. In this case, the transmission zone 426 is made in another material, or by thinning for example.
made of a non-reflective material, or partially permeable to electromagnetic waves, but covered with a reflective layer outside the zone 426. The transmission wall 361 comprises a face internal to the reflecting cavity 400 and a face external to this same cavity 400. Either of these faces may be partially covered with such a layer (except at the zone 426). The reflective layer may for example be a coating or plating deposited by a method of physical vapor deposition (PVD) using a metal such as chromium or aluminum.

### The Reflective Wall Assembly (363-366)

The walls of the reflective wall assembly 363-366 can be made of a material capable of reflecting electromagnetic waves, such as aluminum for example. They can be produced for example by casting in a foundry (or by sintering, 3D printing, etc.), optionally with machining/grinding of faces internal to the reflective cavity 400 in order to obtain a reflective appearance.

Alternatively (see FIGS. 4, 5 and 6), the walls of the reflective wall assembly 363-366 can be made of a plastic material. They can be produced by molding, in particular by injection molding. In this case, the walls are covered with a reflective layer able to reflect the electromagnetic waves in the reflective cavity 400. This reflective layer may be a coating or plating deposited by a physical vapor deposition (PVD) process using a metal such as chromium or aluminum. This reflective layer may also be a metal powder deposited by spraying, or an overmolded, inserted or glued metalized film, or an overmolded metal cage.

Preferentially, the reflecting walls 363-366 comprise a first pair of reflecting walls 363-364 facing each other, and a second pair 365-366 of reflecting walls facing and substantially perpendicular to the walls of the first pair 363-364. Also preferentially, the walls of the reflective wall assembly 363-366 are substantially perpendicular to the first 361 and second 362 walls. Even more preferentially, the walls of the assembly 360 of walls delimiting the reflecting envelope are substantially planar so as to optimize the reflection of the waves in the cavity 400. Thus, the housing 350 has a substantially parallelepiped shape.

We will now describe a first embodiment with reference to FIGS. 2 and 3.

According to this embodiment, the walls of the reflective wall assembly 363-366 comprise a first pair of reflective walls 363-364 facing each other, and a second pair 365-366 of reflective walls facing and substantially perpendicular to the walls of the first pair 363-364. In addition, the walls of the reflective wall assembly 363-366 are substantially perpendicular to the first 361 and second 362 walls.

The walls 360 are substantially planar (see FIG. 3) at least in their parts facing the cavity 400, so as to optimize the reflection of the waves in the cavity 400.

The first pair of reflective walls 363-364 forms a pair of flanges (see FIG. 2), made of molded aluminum and machined for example, able to fit tightly to the ends of the second reflective wall pair 365-366.

The second pair 365-366 of reflecting walls may for example be cut sections to the desired length of extruded aluminum profiles. The first pair of reflecting walls 363-364 comprises grooves/slides to position the first 361 and second 362 walls, and hold them in position. The first pair of reflecting walls 363-364 also comprises anti-deformation stiffeners in order to better withstand shocks and/or to limit the effects of thermal expansion. The depth and shapes of the interlocking between the pairs 363-364 and 365-366 perform a baffle effect providing the seal to the propagation of waves as well as the perpendicularity between the faces.

We will now describe a second embodiment with reference to FIGS. 4 to 6.

According to this embodiment, the housing 350 is made in two parts, a cover 350A and a receptacle 350B. Each part 350A, 350B preferably forms a bowl comprising a bottom wall, and/or lateral walls. According to one embodiment shown in FIGS. 4 and 5, the lateral walls of each part are provided with an edge forming a peripheral flange for fastening the two parts together. Preferably, a seal is positioned all along the flange.

According to a variant not shown, the cover 350A may be substantially flat, that is without a lateral wall. The cover 350A then has a rim in the extension of the flat to bear against the rim of the receptacle 350B. According to this variant, the assembly of reflective lateral walls 363-366 is carried by the receptacle 350B. Conversely, the receptacle can be virtually flat, the assembly of the reflective lateral walls 363-366 being carried by the cover 350A.

FIG. 4 shows the housing 350 seen from above, and FIG. 5 shows the housing 350 seen from below.

Reference is now made to FIG. 6, which shows an exploded view of the antenna 300. The first part 350A of the housing 350 forms a cover, and receives the first wall 361. Preferably, this cover 350A comprises on its bottom wall an orifice opposite the electromagnetic wave transmission zone 426 between the inside and the outside of the housing 350. This cover 350A also comprises, preferably on a lateral wall (other than the wall bearing the orifice), a connector 370 for a waveguide. According to another variant, in particular when the cover 350A is substantially flat, it is the receptacle 350B which comprises, preferably on a lateral wall, the connector 370 for waveguide.

The receptacle 350B of the housing 350 receives the second wall 362. This receptacle 350B comprises, on its bottom wall, a connector interface 353 making it possible to insert the control connection elements 556, used to connect the base surface 500 to a control beam 800 (not shown).

According to this example, the housing 350 also comprises secondary control electronics 550 of the controlled surface. According to this example, this secondary control electronics 550 is positioned opposite the connection interface 353, and between the bottom wall of the receptacle 350B and the guide wall 362. According to a preferential alternative embodiment, not shown, this secondary control electronics is integrated directly into the guide wall 362, preferably on the external face to the cavity (362e).

The lateral walls (walls other than the bottom wall) of at least one of the two portions 350A, 350B form the set of reflective lateral walls 363-366 of the housing 350.

According to a variant of this second embodiment, a first seal 381 is positioned between the cover 350A and the first wall 361. According to a variant of this second embodiment, a second seal 382 is positioned between the receptacle 350B and the second wall 362.

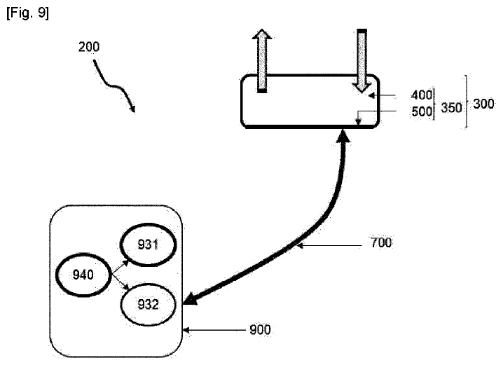

We will now describe a third embodiment with reference to FIGS. 7 and 8.

Reference is now made to FIG. 7, which shows an exploded view of the antenna 300. According to this embodiment, the assembly of reflective lateral walls 363-366 are made in one piece and form a frame 367 covered by the first wall 361 and resting on the second wall 362.

Preferably, the reflective lateral walls 363-366 comprise a rim forming a flange enabling the frame 367 to be fixed to the second wall 362.

Each part 350A, 350B, forms a bowl comprising a bottom wall, and lateral walls provided with a rim forming a peripheral flange for fastening the two parts together. Preferably, a watertight seal is positioned all along the flange.

The cover 350A of the housing 350 forms a cover, and receives the reflecting frame 367 and, on its bottom wall, the first wall 361. Preferably, this cover 350A comprises on its bottom wall an orifice opposite the electromagnetic wave transmission zone 426 between the inside and the outside of the housing 350. This cover 350A also comprises, preferably on a lateral wall (other than the wall bearing the orifice), a connector 370 for a waveguide.

The second part 350B of the housing 350 forms a receptacle, and receives the second wall 362. This receptacle 350B comprises, on its bottom wall, a connector interface 353 making it possible to insert the control connection elements 556, used to connect the base surface 500 to a control beam 800 (not shown).

According to this example, the housing 350 also comprises secondary control electronics 550 of the controlled surface. According to this example, this secondary control electronics 550 is positioned opposite the connection interface 353, and between the bottom wall of the receptacle 350B and the guide wall 362. According to a preferential alternative embodiment, not shown, this secondary control electronics is integrated directly into the guide wall 362, preferably on the external face to the cavity (362e).

FIG. 8 shows a perspective and cross-sectional view of the directional antenna of FIG. 7, in order to better understand the device once assembled.

According to a variant of this second embodiment, a first seal 381 is positioned between the cover 350A and the first wall 361. According to a variant of this second embodiment, a second seal 382 is positioned between the receptacle 350B and the second wall 362.

According to another variant, not shown, the reflecting frame 367 is received by the receptacle 350B, the cover 350A being able to be substantially flat.

The present disclosure also relates to a radar system 200 comprising at least one directional antenna 300 according to an embodiment. Referring to FIG. 9, which represents a particular example embodiment, the radar system 200 comprises:
an electronic unit 900 located outside and at a distance from the housing 350, comprising a primary transmitter 931 and a primary receiver 932 of electromagnetic waves;
at least one waveguide 700 for propagating electromagnetic waves between the primary transmitter 931 and the cavity 400 and between the cavity 400 and the primary receiver 932.

The electronic unit 900 is configured to operate at frequencies greater than 60 GHz, in particular between 75 and 80 GHz, preferably at 77 GHz.

Preferably, the electronic unit also comprises control electronics 940 of primary transmitters 931 and primary receivers 932.

The disclosed embodiments also relate to a bodywork part 100 comprising a directional antenna 300 according to an embodiment.

Finally, the present disclosure also relates to motor vehicle 1 comprising a bodywork part 100 according to an embodiment.

The present disclosure is not limited to the embodiments presented, and other embodiments will become clearly apparent to the person skilled in the art.

What is claimed is:

1. A motor vehicle radar system directional antenna, comprising:
a housing, wherein the housing includes a reflective envelope having an interior volume forming a cavity that is reflective for electromagnetic waves, wherein said reflective envelope is bounded by a set of walls, wherein the set of walls further comprises:
a first transmission wall comprising an electromagnetic wave transmission zone between an inside and an outside of the housing;
a second guide wall, opposite to the first transmission wall, that is adapted to guide electromagnetic waves toward the first transmission wall or toward a waveguide; and
a set of reflective lateral walls connecting the first transmission wall and the second guide wall, wherein each lateral wall is adapted to reflect the electromagnetic waves within the reflective cavity.

2. The directional antenna according to claim 1, wherein at least one of the walls the first transmission wall, the second guide wall, and the reflective lateral walls comprises, on its external face to the reflective cavity, a connector for the waveguide.

3. The directional antenna according to claim 2, wherein a face external to the cavity or an internal face of the second guide wall constitutes a surface reflective to the electromagnetic waves present in the reflective cavity.

4. The directional antenna according to claim 1, wherein the second guide wall constitutes a printed circuit.

5. The directional antenna according to claim 4, wherein the printed circuit includes an internal face turned towards the interior of the reflecting cavity, and on which a metasurface is printed.

6. The directional antenna according to claim 5, wherein the metasurface comprises a controlled surface and diodes, and the printed circuit comprises on its external face, or is connected to, a secondary control electronics of the controlled surface.

7. The directional antenna according to claim 1, wherein the electromagnetic wave transmission zone is covered with a layer partially reflective to electromagnetic waves.

8. The directional antenna according to claim 1, wherein the set of reflective lateral walls is made of aluminum or plastic covered with a reflective layer able to reflect the electromagnetic waves in the reflecting cavity.

9. The directional antenna according to claim 1, wherein the set of reflective lateral walls is made in one piece.

10. The directional antenna according to claim 1, wherein the set of reflecting lateral walls comprises a first pair of reflecting walls facing each other, and a second pair of reflective walls facing and substantially perpendicular to the walls of the first pair of reflecting walls.

11. The directional antenna according to claim 10, wherein the housing has a substantially parallelepiped shape.

12. The directional antenna according to claim 10, wherein the first pair of reflecting walls is adapted to fit tightly into the second pair of reflective walls.

13. The directional antenna according to claim 1, wherein the housing comprises a cover and a receptacle made of a plastic material.

14. A radar system comprising at least one directional antenna, wherein said directional antenna comprises:
a housing, wherein the housing includes a reflective envelope having an interior volume forming a cavity that is reflective for electromagnetic waves, wherein said reflective envelope is bounded by a set of walls, wherein the set of walls further comprises:
a first transmission wall comprising an electromagnetic wave transmission zone between an inside and an outside of the housing;
a second guide wall, opposite to the first transmission wall, that is adapted to guide electromagnetic waves toward the first transmission wall or toward a waveguide; and
a set of reflective lateral walls connecting the first transmission wall and the second guide wall, wherein each lateral wall is adapted to reflect the electromagnetic waves within the reflective cavity.

15. The radar system according to claim 14, further comprising:
an electronic unit located outside and at a distance from the directional antenna housing, wherein the electronic unit comprises a primary transmitter and a primary receiver of the electromagnetic waves; and
at least one waveguide for propagating the electromagnetic waves between the primary transmitter and the reflective cavity and between the reflective cavity and the primary receiver.

16. The radar system according to claim 15, wherein the electronic unit is configured to operate at frequencies greater than 60 GHz.

17. A bodywork part comprising a directional antenna, wherein said directional antenna comprises:
a housing, wherein the housing includes a reflective envelope having an interior volume forming a cavity that is reflective for electromagnetic waves, wherein said reflective envelope is bounded by a set of walls, wherein the set of walls further comprises:
a first transmission wall comprising an electromagnetic wave transmission zone between an inside and an outside of the housing;
a second guide wall, opposite to the first transmission wall, that is adapted to guide electromagnetic waves toward the first transmission wall or toward a waveguide; and
a set of reflective lateral walls connecting the first transmission wall and the second guide wall, wherein each lateral wall is adapted to reflect the electromagnetic waves within the reflective cavity.

18. A motor vehicle comprising the bodywork part according to claim 17.

19. The radar system according to claim 15, wherein the electronic unit is configured to operate at frequencies between 75 and 80 GHz.

20. The radar system according to claim 15, wherein the electronic unit is configured to operate at frequencies of 77 GHz.
